(19) United States
(12) Patent Application Publication
(10) Pub. No.: US 2006/0190257 A1
(43) Pub. Date: Aug. 24, 2006

(54) Apparatus and methods for vocal tract analysis of speech signals

(75) Inventors: Barbara Janey Forbes, London (GB); Edward Roy Pike, Worcester (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: King's College London, London (GB)

(21) Appl. No.: 10/548,844

(22) PCT Filed: Mar. 15, 2004
(86) PCT No.: PCT/GB04/01091

§ 371 Date: Mar. 3, 2006

(30) Foreign Application Priority Data
Mar. 14, 2003 (GB) 0305924.3
Dec. 4, 2003 (GB) 0328161.5
May 22, 2003 (WO) PCT/GB03/02240

(51) Int. Cl. G10L 15/28

(52) U.S. Cl. 704/255

(57) ABSTRACT

The present invention provides for speech processing apparatus arranged for the input or output of a speech data signal and including a function generating means arranged for producing a representation of a vocal-tract potential function representative of a speech source and as an example, a speaker identification process can comprise means to capture an incoming voice signal, for example from a microphone or telephone line; means to process the signal electronically to generate a time varying series of binary vocal-tract potentials and associated non-vowel binary parameters; means to refine the signal to revoke the speaker-independent speech components; and means to compare the residual signal with a database of such residual features of known individuals.

The present invention relates to a speech processing apparatus and method and, in particular, but not exclusively, to such an apparatus and method for use within a speech recognition, speech synthesis, speech compression or a voice identification system.

Known speech processing systems such as speech recognition systems are based on techniques including the generation of a Hidden Markov Model (HMM) and some such systems attempt to use vocal-tract parameters to improve performance.

One example of such a known arrangement is disclosed in U.S. Pat. No. 6,236,963, which, amongst its various examples, discloses a speech recognition system employing a generated HMM, and also a function generation means for establishing a vocal-tract area function. Further known research relating to articulatory levels of representation in the HMM are also known but there is no clear indication as to how such levels should be structured or, indeed, which articulatory parameters the modeling should be applied to.

Such known systems are disadvantageous particularly due to their employment of the vocal-tract area function, which is problematic due to non-unique mapping between the vocal-tract and the transmitted speech signal, and so the vocal-tract area function can be seen as a disadvantageously limited descriptor of the speech signal.

In general, currently known systems such as those known from U.S. Pat. No. 6,236,963 are considered to suffer disadvantageous limitations with regard to the vocabulary size and the range of speaker characteristics, such as dialect differences, that can be handled. In general, and with regard to the operational efficiency in spontaneous speech conditions, it is found that current systems can readily fail when syllables are found to run into each other as in natural “joined up” speech.

The problem of the definition of a compact set of control parameters for speech acoustics remains topical due to the limitations of current HMM systems in their dealing with the general area of phonological variation, for example, continuous speech phonotactics and long-range context dependencies.

The known systems can however, to some extent, be arranged to provide some form of useful functionality through the adoption of a trade-off between the above-mentioned potential problems. For example, a system arranged for use with a restricted vocabulary, or only isolated phrases, can be achieved and which is somewhat speaker-independent. A simplistic form of such a known system is arranged to discriminate between “yes” and “no” responses given orally via a telephone link and which are employed in, for example, targeted telesales services.

However, and as mentioned, such known systems are far from offering, for example, automated speech recognition that can allow for recognition under spontaneous speech conditions.

The present invention seeks to provide for a speech processing apparatus and method exhibiting advantages over known such apparatuses and methods and, in particular, one which can be employed in a speech recognition system.

The invention is based upon a consideration of the physics of speech production with a view to defining an abstract level of representation pertinent to the phonetics phonology interface.

According to one aspect of the present invention, there is provided a speech processing apparatus including a function generating means arranged for estimating a vocal-tract potential function.

Advantageously, the invention provides for defining parameters as a six bit potential function for vowel sounds.

This invention is advantageous insofar as it allows for the application of mathematical processing of quantum-mechanics to speech processing. By adopting the analytical methods of quantum mechanics, the invention takes into account the geometric and acoustical properties of known potential-function types, particularly the barrier and well. Specifically, the formalism is able to quantify dispersion in regions of tract expansion and contraction, accounting for phenomena occurring at rapid changes in tract cross-section in a more accurate manner than allowed by stepped “n-tube” models. A perturbation analysis made on the basis of small dispersions, rather than small changes in tract area, leads to a definition of just six bitwise parameters, which combine in a simple manner to generate a 25-vowel space. Together with the generation of five or six bit consonantal feature vectors, the invention can therefore find ready use in systems such as speech recognition and speech synthesis.

In a further aspect, and for consonant sounds, the parameter can be defined as in the region of five or six additional bits so as to provide for single-bit characteristic consonantal features.

Thus when also considering the consonantal feature vectors, it will be appreciated that the invention can provide for a practical eleven-bit voice recognition system with six bits being employed for vowel sounds, and a further five for consonants.

For a potentially greater accuracy however, a twelve-bit system can be provided employing six bits for vowel sounds and a further six bits for consonants.

As will be appreciated the invention relates to the parameterization of vocal-tract geometry as a potential function.

Also, in view of the advantageous back-calculation of a potential function that can be achieved from an emitted wave, the speech processing of the present invention lends itself advantageously to either speech recognition or speech synthesis.

Advantageously, the vocal-tract potential function is described by one general function and, yet further, such general function can be employed to describe each of the internationally recognized distinct phonemes by means of specifying a small number of parameters of that function.

Also, each of the aforementioned parameters can comprise binary parameters and, yet further, characteristics of the function are found to be both speaker-specific and speaker-nonspecific.

The invention can provide for a speech processing system in which an input sound wave is recorded and digitized and an inversion calculation performed so as to arrive at the said potential function.

Preferably, the potential function is divided between speaker-dependent and speaker-independent sections.

The speaker-dependent sections can be arranged to be compared with the content of a storage means so as to perform voice identification.

Also, the speaker-independent parts can be subsequently processed to provide for speech recognition.

Yet further, the speech recognition apparatus includes comparison means for comparing binary parameters of an invariant part of the sound signal with the content of a look-up table.

Still further, means can be provided for forwarding a stream of binary parameters into a speech parser.

Advantageously, the speech parser is arranged to confirm and/or refine interpretation by means of, for example, grammar and/or context rules.

As an alternative, apparatus can be provided for receiving the speaker independent parts of a potential function as the compressed, speech signal, in addition to the speaker-dependent parts of the said, general, potential function together with voicing information for the reconstruction of a sound wave.

According to another aspect of the present invention there is provided a method of speech processing including the step of estimating a vocal-tract potential function and generating a general function therefrom and employing parameters thereof for representing phonemes.

Again, in this aspect of the invention, the invention provides for defining parameters as a six bit potential function for vowel sounds, and preferably with five or six additional bits for consonant sounds.

It should be appreciated therefore that the concept underlining the present invention achieves its advantages through the derivation of a physical analysis of wave propagation in the vocal-tract that is based on quantum-mechanical scattering systems.

Advantageously therefore, the invention provides for the application of modern physics to the known speech inversion problem in which vocal-tract parameters are to be identified from an acoustic signal recorded at some point outside the mouth.

Thus, the invention can provide for a speech processing control unit, in which a vocal-tract potential function is derived from digitized speech by an inversion algorithm based on solution for the vocal-tract wave function, ψ. The invention advantageously serves to identify unique vocal-tract parameters from a recorded acoustic signal.

The general potential function obtained is then separated into a speaker-dependent part, which contains information about the tract length, and may also include details of the glottal vibration, and a speaker-renormalized part, which is obtained by algorithms such as least-squares fit onto previous defined, mainly binary, potential function strings stored in a look-up table. Vocal-tract renormalization is implicit in the process since the binary strings have the unique feature of being scaled by the tract length. Information retrieved as noted above, or individual voice characteristics obtained by other methods, may be recombined with the compressed data for re-synthesis by wave equation methods, in a speech synthesizer.

For each of the above-mentioned purposes therefore, a practical eleven-bit voice processing system can be provided with six bits employed for vowel sounds and five for consonants. Greater accuracy can be achieved by increasing the number of bits for the consonant sounds to six.

According to a further aspect, the invention proposes the concept of solving the inverse problem by means of an analysis taking the autocorrelation function of the speech signal as a basis for the solution of the problem. In this method the running short-term autocorrelation function, over only a few glottal cycle times, reveals a relatively stable and smoothed representation of the structure of the signal as it evolves during and between phonemes. Inversion of the signal from this representation is particularly advantageous for defining the consonantal feature vectors, which vary on this short time scale, and thus are not particularly well represented by Fourier transformation over the longer sample times used in the present art.

The invention is described further hereinafter, by way of example only, with reference to the accompanying drawings in which:

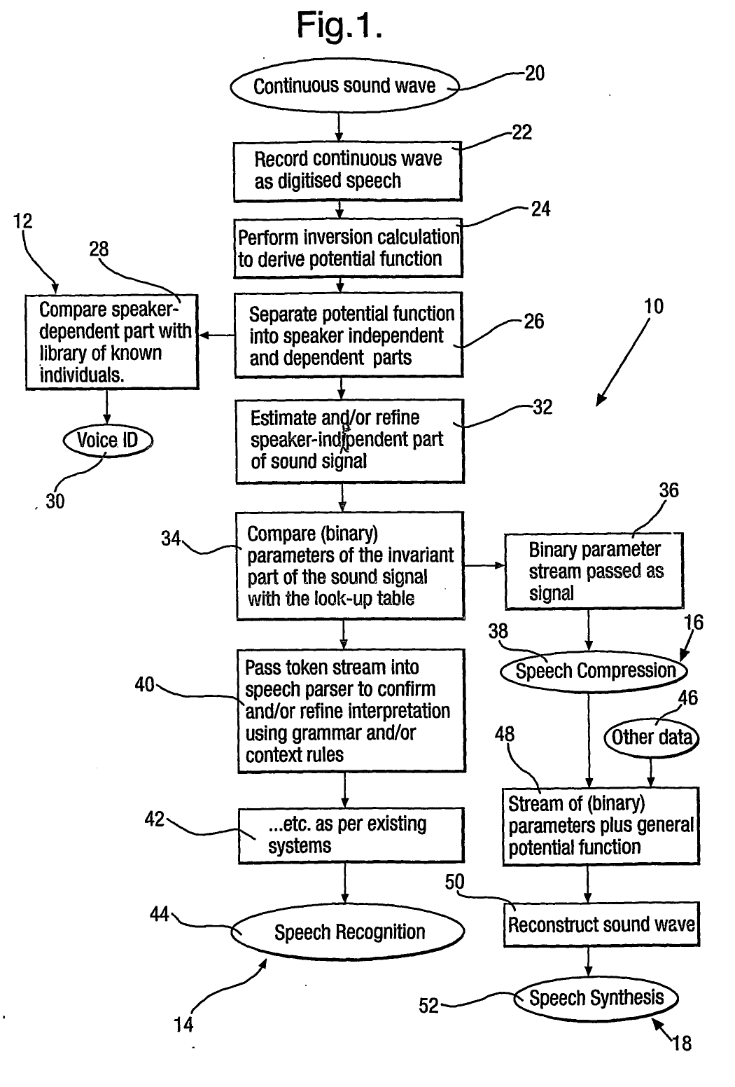

FIG. 1 is a flow diagram illustrating the concept of the present invention particularly as applied to speech recognition, speech synthesis, speech compression and voice identification techniques;

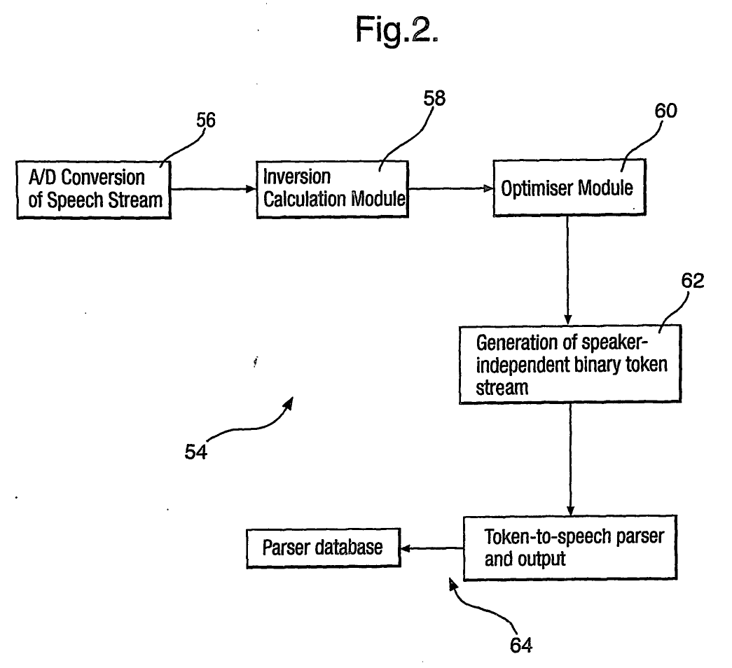

FIG. 2 is a block diagram of speech recognition apparatus embodying the present invention;

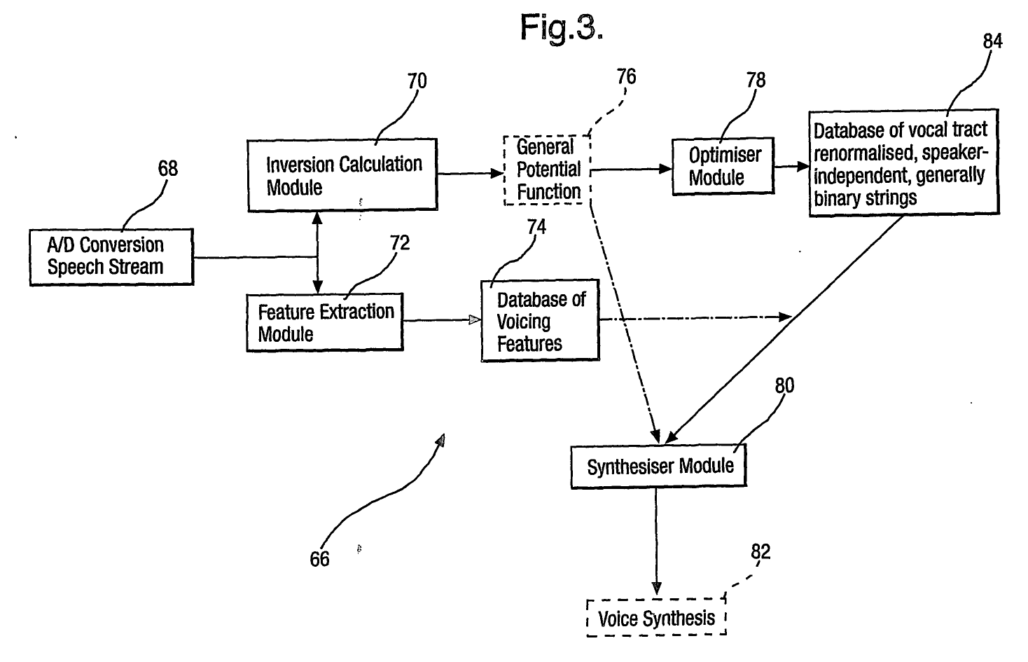

FIG. 3 is a schematic block diagram of speech synthesis apparatus embodying the present invention;

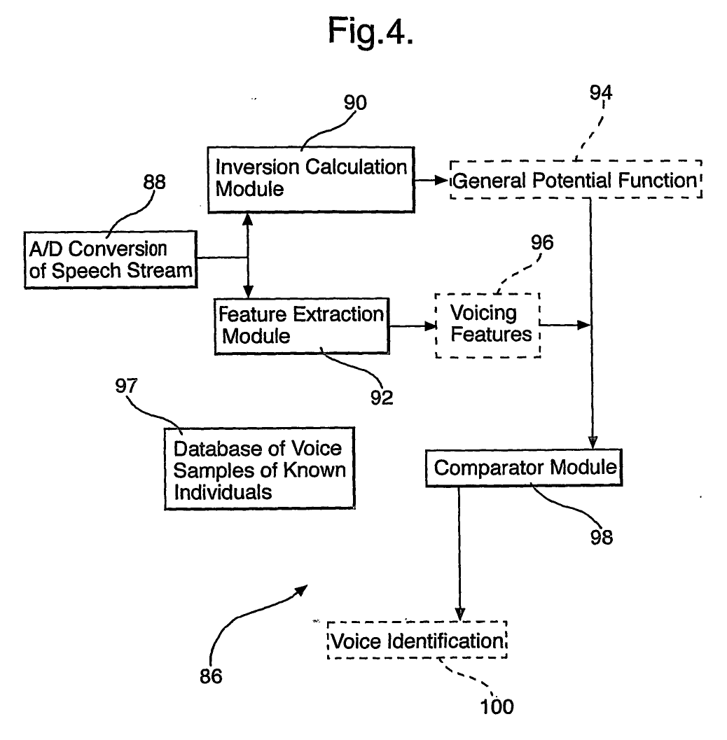

FIG. 4 is a schematic block diagram of voice identification apparatus embodying the present invention;

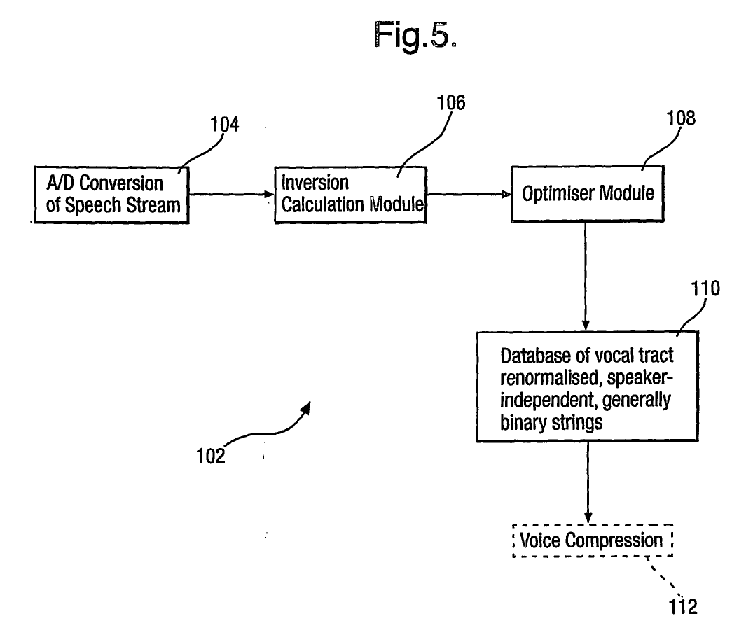

FIG. 5 is a schematic block diagram of speech compression apparatus embodying the present invention;

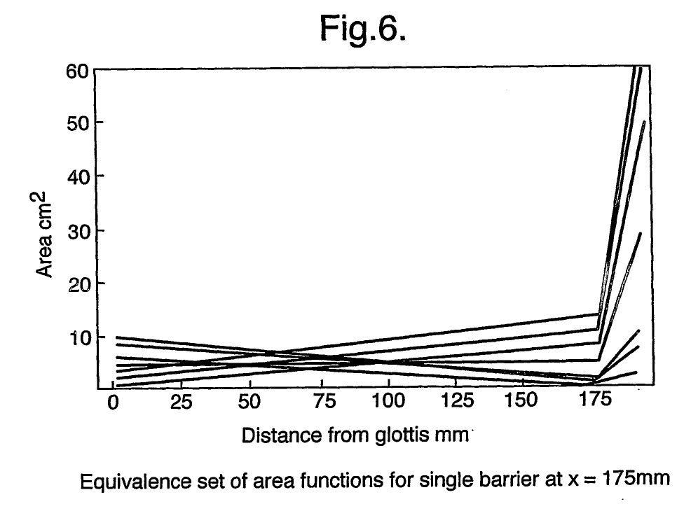

FIG. 6 illustrates an equivalence set of area functions mapped to a potential function;

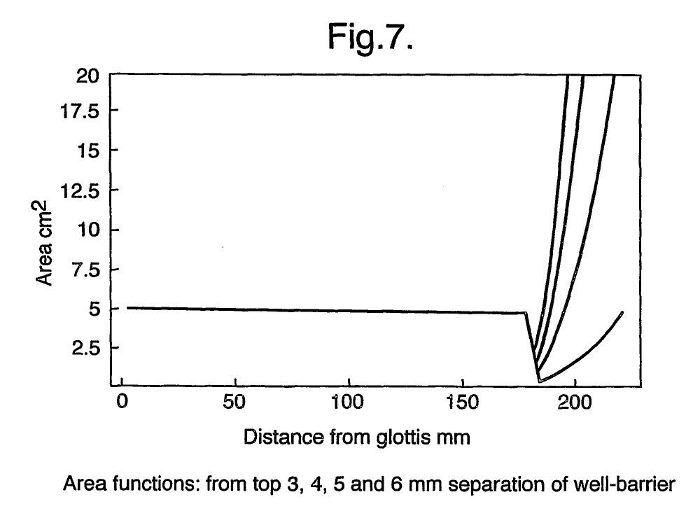

FIG. 7 illustrates an area function once a well has preceded a terminating barrier;

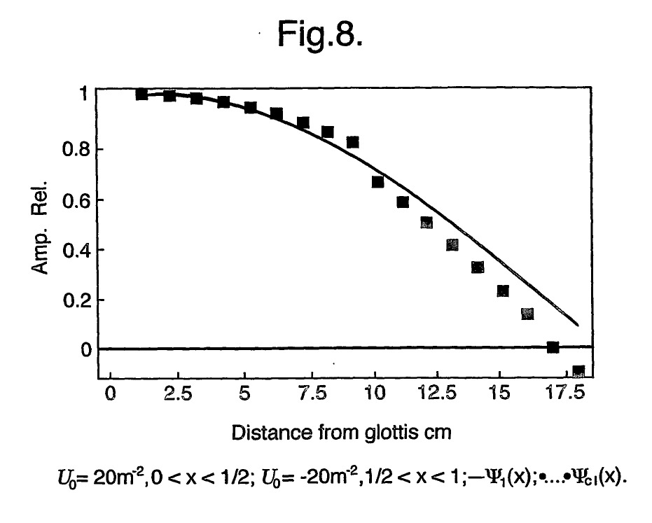

FIG. 8 is a graphical illustration of the phase of the constructive effects on a first eigenfucntion;

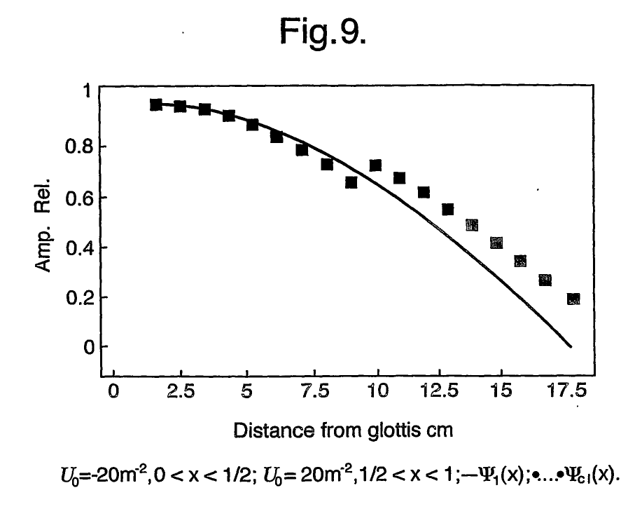

FIG. 9 is a graphical illustration of a destructive flattening effect with a reverse potential configuration;

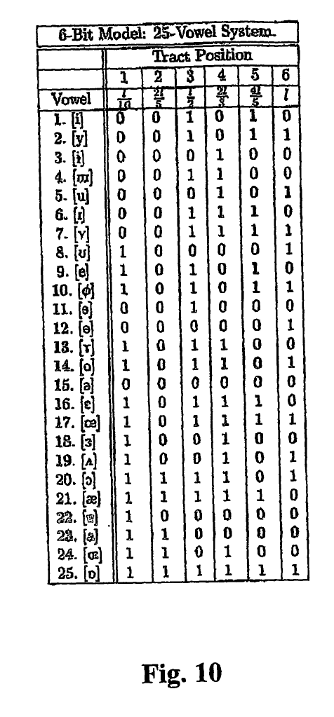

FIG. 10 is a table illustrating a six-bit vocal tract model for a 25 vowel system; and

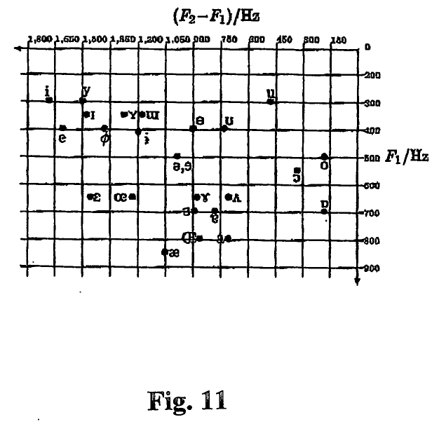

FIG. 11 comprises a vowel chart corresponding to the table of FIG. 10.

Turning first to FIG. 1, there is provided a flow diagram 10 illustrating an embodiment of the present invention and, in particular, four particular aspects relating to voice identification 12, speech recognition 14, speech compression 16 and speech synthesis 18.

As will be appreciated from the flow diagram, each of the four aforementioned different aspects of the present invention share common features which are illustrated by the common sections of the flow diagram.

In the flow diagram, speech data in the form of a continuous sound wave 20 is recorded as digitized speech at step 22 and, in accordance with the particularly novel feature of the present invention, an inversion calculation is then performed on the digitized speech signal at 24 so as to derive a vocal-tract potential function.

At step 26, the potential function is separated into speaker-independent and speaker-dependent parts.

The voice identification process requires access merely to the speaker-dependent parts of the potential function and so at step 28 such parts are compared with stored data comprising a library of known individual characteristics, which comparison can lead to voice, and thus individual, identification such as at step 30.

Returning to the main path of the flow diagram, the speaker-independent part of the sound signal as represented by the potential function can be estimated and/or further refined at step 32 for a subsequent, and prefably binary comparison step of the invariant part of the sound signal with data stored in a look-up table at step 34. The binary parameter stream obtained at step 34 is retrieved for the subsequent speech compression as illustrated at steps 36 and 38.

The step 34 will also produce a phoneme stream, which, at step 40 is delivered to a speech parser to allow for confirmation, and/or refinement, on the basis of standard grammar and/or context rules.

The processing continues via step 42, which represents standard final stages in speech recognition processing so as to provide for the required speech recognition at the step 44.

Returning to the speech compression step 38, it will be appreciated that the compressed data, and the parameterized control data 46 are combined at step 48 so as to provide a stream of, prefably binary, parameters in addition to data relating to the potential function. Such combined data is reconstructed as a sound wave at step 50 so as to provide for a speech synthesis output at step 52.

As will be appreciated from the foregoing, a particularly important aspect of the present invention is that the speech processing is derived from a physical analysis of wave propagation in the vocal tract that shares a framework with quantum-mechanical scattering systems. The invention is therefore derived from the application of modern physics to speech inversion and in which vocal-tract geometry is sought from the acoustic signal recorded at some point outside the mouth. The definition of a maximally small number of parameters to describe the speech signal has long been thought to involve the vocal-tract configuration but is, in fact, an unsolved problem of Automated Speech Recognition technology.

However, as the present invention now confirms, an equation, mathematically analogous to the Klein-Gordon equation of quantum mechanics, can be employed for the description of one-dimensional acoustic systems. As will be appreciated this wave mechanical formalism leads to a unique and compact parameterization of the vocal-tract geometry in terms of a tract potential function. While the standard known description, in terms of a tract area function, leads to a problem of non-unique mapping between the tract and the transmitted speech signal, for ASR technology the vocal-tract area function is a problematic descriptor of the speech signal. The tract potential function employed in its place within the present invention exhibits advantages of simplicity accuracy and reliability that serve to render the processing system of the invention particularly suited to the requirements of speech recognition, synthesis, compression and voice identification.

As noted previously, the process employed within the present invention is advantageously arranged to allow for the scaling of the potential function to vocal-tract length so as to achieve vocal-tract renormalisation. Also, the method of inversion of the speech signal so as to provide the vocal-tract length and the six binary parameters for vowels, and the five or six binary parameters for consonants, may advantageously include the option of noise reduction algorithms such as weiner filtering and/or other steps in the processing procedure such as blind equalization, blind deconvolution or preemphasis.

Turning now to consonant sounds within the acoustic signal, the present invention provides for the use of a relatively small number of generally binary parameters, such as in the order of five or six, to allow for the description of such consonants.

Advantageously, such five or six parameters comprise a parameter on the potential function that represents a class of nasals, which could comprise vowels or consonants, and with an acoustic cue relating to the low energy around the first harmonic frequency, and possible rapid rise in frequency following a vowel. Further, the parameters can comprise a parameter serving to indicate the class of glides, a parameter serving to indicate the class of plosives and with acoustic cue relating to an abrupt drop in energy. Still further parameters can comprise a parameter on the potential function that serves to indicate the class of laterals and a parameter that serves to represent the class of voiceless consonants and allied with acoustic cue of aperiodic energy and a high zero-crossing rate.

With such parameters, the voicing, at the speaker glottis, of speech may be taken as a default position.

From the above-mentioned discussion of the processing of vowel and consonant sounds, it will be appreciated that the present invention can allow for the admission of an inventory of in the order of eleven or twelve generally binary parameters to account for complete speaker-independent speech recognition. The use of such a number of binary parameters enhances the efficiency of the processing, which efficiency can be improved even further by a reduction in the number of parameters as follows.

As an alternative, and as discussed further below, in relation to FIG. 10 of this application, the additional binary parameters for consonant sounds can be derived from the same six-bit table providing representation of a 25-bit system prepared primarily as a representation of vowel sounds. In this manner, in the order of nine, rather than in the order of ten-twelve binary parameters will then be required so as to provide full phonetic representation which will of course lead to a yet further reduction in the number of parameters required for full speech processing and thereby lead to further increase in overall efficiency.

Although particular details of the processing required by embodiments of the present invention are outlined later, there now follows a description of four different aspects of the present invention comprising a speech recognition system, a speech synthesis system, a voice identification system and a speech compression system illustrated in accordance with the schematic diagrams of FIGS. 2-5.

Turning first to FIG. 2, there is illustrated in block schematic form a speech recognition system 54 including a speech capture and conversion unit 56 by which an incoming analogue speech signal is converted to a digital speech signal for subsequent processing within the speech recognition system 54. The digitized speech signal is delivered to an inversion calculation module 58, which, in accordance with the present invention, is arranged to perform an inversion calculation on the incoming signal so as to derive an associated potential function.

The resulting signal from the inversion calculation module is delivered to an optimizer module 60 which can lead to the generation of a speaker-independent binary token stream 62 which are subsequently delivered to a binary string parser arrangement 64 including a parser database. As required, the parser is arranged to confirm and/or refine interpretation of the received speech signal by means of, for example, grammar and/or context rules. The output signal from the arrangement 64 can then be processed in the same manner as conventional systems so as to produce, for example, a recorded, or displayed speech recognition result.

Turning now to FIG. 3, there is illustrated a speech synthesis system 66 according to an embodiment of the present invention. In this illustrated example, a digitized representation of a speech sound wave is obtained at the capture and conversion unit 68, the output of which is delivered to an inversion calculation module 70 and a feature extraction module 72. A database 74 of stored voicing features is arranged to receive the output from the feature extraction module and, as will be described further below, produce an output serving to influence control a voice synthesizer module.

As with the speech recognition system illustrated in FIG. 2, the output from the inversion calculation module 70 of the speech synthesis system 66 produces a general potential function 76, which is delivered to both an optimizer module 78 and the aforementioned speech synthesizer module 80. A stream of the binary parameters is output from a database 84 of vocal-tract renormalized, speaker-independent, generally binary strings, which output is influenced by the output from the database 74 of voicing features and which, in combination with the general potential function 76, serves to control the speech synthesis at the speech synthesizer module 80 so as produce a synthesized voice output 82.

With regard to FIG. 4, there is illustrated a voice identification system 86 which, as with the embodiment of the present invention illustrated in FIG. 3, employs a capture and conversion module 88 arranged to deliver a signal to each of an inversion calculation module 90 and a feature extraction module 92. Again, the inversion calculation module serves to generate a general potential function 94 which, in combination with the voicing feature 96 output from the feature extraction module 92 is delivered to a comparator module 98 which is also arranged to receive an output from a database 97 of voice samples of known individuals.

The comparison of the speaker-dependent part of the potential function 94 with the voice samples in the database 97 relating to known individuals, serves to provide for a voice identification output result 100.

Turning now to FIG. 5, there is illustrated an example of a speech compression system according to an embodiment of the present invention. Here, the output from a capture conversion module 104 is again delivered to an inversion calculation module 106 so as to derive a potential function and the output from the inversion calculation module 106 is delivered to an s optimizer module 108. The optimizer module 108 output is delivered to a database for comparison with vocal-tract renormalized, speaker-independent, generally binary strings so as to produce a binary parameter stream representative of the incoming speech signal.

Such a binary representation of the incoming speech signal can then advantageously exhibit a compressed format so as to provide for the required speech compression.

The processing relating to generation of the potential function relative to the inversion calculation, and the generating of the potential function, is now described in further detail.

It has previously been noted that the pressure P(x), and area, S(x), functions, appearing in the Webster equation, must together obey the principle of conservation of energy such that, averaged over a period, τ,
<P′²(x, t)>S(x)=const. (1)

Defining a new variable, the wavefunction, ψ,
ψ(x,t)=P′(x,t)S(x)^{1/2} (2)

thus removes much of the predictable fluctuation of pressure with axial distance and elucidates the physically significant dispersive phenomena. Substitutions for P′(x,t) within the Webster equation then result in the Klein-Gordon form:

$$\frac{{\partial }^{2} Ψ ( x , t )}{\partial {t}^{2}} = {c}^{2} \{ \frac{{\partial }^{2} Ψ ( x , t )}{\partial {x}^{2}} - U ( x ) Ψ ( x , t ) \} . \qquad ( 3 )$$

Equation (3) has the form of a wave equation holding under the assumptions of one-dimensional propagation in a compressible fluid, in the non-viscous approximation, where ψ²(x,t) is directly propagation to the potential energy per unit length of fluid. The potential function, U(x), is defined in terms of a continuously defined area function S(x), that is,

$$U ( x ) = \frac{{d}^{2} S {( x )}^{1 / 2} / {dx}^{2}}{S {( x )}^{1 / 2}} . \qquad ( 4 )$$

Two cases of special interest arise, namely those of the positive (“barrier”) and negative (“well”) potentials.

For a piecewise-continuous potential function, U₀, where U₀>0, time-independent solutions, ψ(x), are found in terms of a dispersive wave number, k′, such that k′=(k²−U₀)^{1/2}. A wave propagates with increased phase velocity over such a barrier, and is exponentially decaying within it, that is, for k²<U₀.

Given U₀, an underlying area function can be recovered from equation (4) only for two known initial conditions on S(x)^{1/2}. For a known area, S(0), at the glottal boundary and zero initial gradient dS(x)^{1/2}/dx=0, a particular solution is found such that
S(x))^{1/2}=S(0)^{1/2}cosh U₀^{1/2}x, (5)

describing a section of catenoidal horn.

For U₀<0, the dispersion is then such that k′=(k²+|U₀|)^{1/2}. A wave propagates, with decreased phase velocity over such a barrier, and may be bound within it. For the initial conditions as in the situation U₀>0 above, it is found that
S(x)^{1/2}=S(0)^{1/2}cos|U₀|^{1/2}x. (6)

In general, however, any particular potential function will map to an infinite “equivalence set” of area functions. This is illustrated in FIG. 6 for a single barrier of 1 mm width and height 10⁵m⁻², terminating a tract of length 175 mm. FIG. 7 shows the effect on the area function of preceding such a terminating barrier with a well of the same dimensions, at varying separation of the pair. Localized constrictions, of degrees increasing with separation length, are obtained. A variety of acoustical effects, not evident in standard accounts, accompany the transition to an approximately single resonator configuration. Following the analysis, simple mathematical constraints were predicted for the height and width of acoustical barriers and wells within a vocal-tract. Constraints were then sought on the positioning of such potentials. This was achieved through a first-order, time-independent perturbation analysis.

In contrast to the standard perturbative account, the following analysis takes account of small dispersions, rather than changes in tract area. Consider a small perturbation around resonances skₙ, such that δkₙ=k′ₙ−kₙ, for k′ₙ=(kₙ²−U₀)^{1/2}. For a tract of length l, the corrected eigenfunctions, ψ_{cn}(x), may be written

$${Ψ}_{cn} ( x ) = {A}_{n} cos \{ [ \frac{( 2 n + 1 ) π}{2 l} + δ {k}_{n} ] x \} . \qquad ( 7 )$$

The corrected potential energy per unit length e_{cpn}, can be written to first order as

$${e}_{cpn} ( x ) = \frac{{A}_{n}^{2}}{4 {ρ}_{0} {c}^{2}} \times ( 1 + cos \begin{matrix}[ \frac{( 2 n + 1 ) π x}{l} ] - \\ 2 δ {k}_{n} x sin [ \frac{( 2 n + 1 ) π x}{l} ]\end{matrix} ) ; \qquad ( 8 )$$

Thus defining a first-order perturbation, δₑₚₙ(x), to the potential energy.

$$δ {e}_{pn} ( x ) = - \frac{{A}_{n}^{2}}{2 {ρ}_{0} {c}^{2}} δ {k}_{n} x sin [ \frac{( 2 n + 1 ) π x}{l} ] . \qquad ( 9 )$$

Since δkₙ is positive for a well but negative for propagation above a barrier, it can be shown that (a) the perturbative term may be in or out of phase with the radiation pressure, thus strengthening or weakening the resonances, respectively; and that (b), a perturbing well or barrier may, by Ehrenfest's theorem, raise, lower or have no effect on an eigenfrequency, depending on the interaction with the phase of the sinusoidal term. These results can be demonstrated by assuming a perturbation δkₙ=±1m⁻¹ which entails U₀˜±(20 m⁻²) at the first eigenfunction of a tract of length 175 mm.

It is found from equation (7), and illustrated in FIG. 8, that constructive effects on the first eigenfunction occur for a barrier perturbation for 0<x<1/2, and a well for 1/2<x<1, since the perturbations are then in phase with the radiation pressure. FIG. 9 illustrates a destructive flattening effect when the reverse potential-function configuration is adopted.

Referring now to FIG. 10, there are shown examples of piecewise-continuous (bitwise) potential-function strings, where the notation refers to predicted mathematical constraints on barrier and well potentials and SWP positions. The results for a 6-bit vocal-tract model are shown of which 4 bits are orthogonal and two exhibit statistical dependencies, and also examples from 25 a vowel system.

The six-bit table of FIG. 10 illustrates how it is possible to differentiate between all linguistic classes for a full 25-vowel system for example round vowels at the 6^{th}-bit, front vowels at the 3^{rd} and 5^{th} bits, low vowels at the first and second bits and rhotic vowels at the 4^{th} bit. FIG. 11 is a vowel corresponding to FIG. 10.

It should therefore be reiterated that, depending on the initial conditions at the glottis, many area functions correspond to any given potential-function string. That is, there is a many-to-one mapping between the area and potential functions. Nevertheless, general comments can be made about possible gestural correlates of the bitwise strings. For example, the 1st and 2nd bits, identified with the non-high vowels, denote a positive tract curvature (most simply, an expansion) at the 1/10 and 21/5—approximately glottal and pharyngeal—regions. The presence of these bits suggests, for example, a retraction of the tongue root. The 3rd and 5th bits correspond to potential-function wells spanning the front half of the vocal tract, and are in line with a constriction extending over the hard palate, typical of the front vowels. The 4th bit typifies a shorter constriction centered in the same region, indicative of the central vowels.

As an alternative to the five or six binary parameters previously discussed for handling the consonant sounds the possibilities for deriving appropriate parameter representation of such sounds from the 6-bit table illustrated in FIG. 10 is also recognized.

This possibility arises through the identification of three further class of sounds from the aforementioned 6-bit table and which comprise nasalised vowels, laterals such as “l-type” sounds, and also rhotic “r-type” sounds referred to generally as steady-state sonorants and as discussed further as follows.

With reference to FIG. 10, it should be appreciated that nasalised vowels can be obtained from a 6-bit string 01xxxx, wherein x refers to either a 0 or a 1. That is to say, any entry illustrated in FIG. 10 and beginning 10xxxx can include a counterpart 01xxxx which indicates the nasalised version of that entry. Thus, ten nasalised vowels can be obtained from the table illustrated in FIG. 10. The notation employed serves to imply a barrier of approximate width and height 1 mm and 10⁴m⁻² respectively at the 21/5 position, and also an implied well at x=l at the limit of bound state solutions for which |Uₒ|Δ²=π²/4.

With regard to the above-mentioned laterals, i.e. the “l-type” sounds, these will be obtained from the 6-bit string xx011x and my be considered as “clear” or “dark” depending on other bits in the string.

Likewise, the rhotic, or “r-type” sounds can be obtained from the 6-bit string xx0011 and can also be considered either “clear” or “dark” depending upon other bits in the string.

Yet further, it is appreciated that it is now possible to state another binary element indicating the absence of periodic voicing at the glottis, which of course would be the default case, and also the presence of aperiodic energy, which characterizes the voiceless sounds and those arising with a so-called breathy voice. The same binary element could also serve to code the distinctive fundamental frequency in voiced sounds such as high tones in tone languages such as Chinese. In such a case, a baseline tone is taken as the default position and considered to correspond to the voicing of sonorants, in nontone languages. Thus, referring again to the table of FIG. 10, it will be appreciated that any string can be proceeded by another entry x(xxxxxx) which may be 0 for a default case for the voicing of vowels/sonorants and with a baseline tone in tone language, or which may be a 1 for voiceless or breathy sonorants, or high tone in tone language.

This additional binary parameter can be considered as a voicing parameter since no particular reference is made to the potential function.

Thus, as will be appreciated from the above, it is considered that all sonorants, i.e. vowels, laterals and rhotics whether nasalised, voiced, voiceless, or breathy voiced sounds can be represented by way of seven binary parameters and it is likewise thought that all remaining consonants can be represented by means of only another two or three binary parameters so that in the order of nine parameters are then required to provide for full representation.

As compared with the previous discussion concerning the use of additional five-six parameters for consonant sounds, it will be appreciated that reliance on the table of FIG. 6 in order to provide the above-mentioned further three classes of sounds leads to yet further improvements in accuracy and efficiency.

Compared to traditional area function tract description therefore, the potential-function formalism has the unique advantage of quantifying the physics of speech production on a level that is both more abstract and compact. Most importantly, the bitwise strings predicted by mathematical analysis have been found to have clearly phonological properties, whilst mapping deterministically to the phonetic level, both aural and in terms of a tract area function. The proposed six-bit model for vowel sounds, together with the five/six bit consonantal parameters allow for a sophisticated implementation of an intermediate representation, specifically a phonetics phonology interface, in an automatic speech recognition architecture such as that discussed herein.

As noted above with regard to speech production it is appreciated within the present invention that just six binary parameters, stated in terms of a potential-function string, are sufficient to synthesize the acoustic characteristics of a full 25-vowel system and as described by the standard phonetic alphabet. The addition of a small number of extra binary parameters, generally in the order of five or six, allows the description of the consonants and other tokens of the speech stream.

A more recently developed inversion technique shows that a unique inverse mapping exists between the speech signal and the vocal tract potential function. The general speech-recognition problem then can be reduced to finding a best fit between the recovered potential function and other non-vowel parameters and “template” binary strings, while other speech processing applications also will be based upon the use of the potential function as a model for speech generation.

Considering now in more detail the inversion calculation, and returning to equation (4) above, it should be noted that the document Benade, A. H. and Jansson, E. V; On Plane and Spherical Horns and Non-Uniform Flare: I Theory of Radiation, Resonance Frequencies, and Mode Conversion; Acustica; Vol. 31 (1974), suggests that the function U(x) plays a similar role to the potential energy function of the Schroedinger equation of quantum mechanics and that it provides complete information about the frequency-dependent reflection (R(k)) and transmission (T(k))coefficients of the acoustic waves in the tract where the wave-vector k is equal to c divided by the frequency w. However, the Klein-Gordon equation has not been used before in the context of speech acoustics and differs from the Schroedinger equation in that the time derivative appears in second rather than in first order. This makes a crucial difference to the time-dependent behavior of the speech waves. The potential function, however plays a similar role as a scattering source in both of these equations when waves of single Fourier frequencies are considered.

For a rectangular barrier, the transmission and reflection coefficients are obtained by the method of matching the wave function T(x,t), and its first derivatives at the barrier edges. The transmission characteristics of such barriers are therefore obtained very directly.

By modeling the tract as a series of barriers of this simple shape it is possible to solve the Klein-Gordon equation analytically and thus obtain the Green's function G_{f}(1|0|w) for the response of a tract of length L, taken at an arbitrary distance, l, outside it, to a volume-velocity input C_{w}e^{iwt} at the glottis. This is equal to the pressure, which would be measured by a microphone placed at this position. In terms of the algebraically calculated reflection and transmission coefficients it is found that

$${G}_{f} ( l \vert 0 \vert w ) = {C}_{w} \frac{T ( k )}{1 - R ( k )} {ⅇ}^{- ⅈ kl} \qquad ( 10 )$$

where C_{w} is the Fourier coefficient of the glottis model, for which, for example, we can use any one of a number in the literature such as the one by Klatt.

The following represents a proof due to Aktosun [Aktosun, T. Construction of the half line potential from the Jost function. IMA Preprint No. 1926 (2003)] that the required inverse mapping can be achieved and further represents one example of how the inversion can be achieved in a frequency dependent manner.

It should of course be appreciated that the invention is not restricted to such details and that other methods can be used.

To invert the measured microphone signal to obtain the potential function we assume, on the basis of our numerical research, that the potential U does not support any bound states. It is real valued, vanishes for x<0, includes no delta distributions, and belongs to L¦(R). R denotes the ponts of the real line and by L¦ (R) we denote the Lebesque-measurable potentials U such that ƒ^{∞}_{-∞}dx(1+|x|)|U(x)| is finite. Under these conditions the following solution has been derived.

The scattering states at frequency w of the Klein-Gordon equation correspond to its solutions behaving like e^{ikx} or e^{-ikx} as x→±∞, and such states occur for kεR\{0}, that is in R excluding the zero point. Among these is the Jost solution from the left, f₁(k,x), satisfying the boundary conditions.
f₁(k, x)=e^{ikx}[1+o(1)], f′₁(k, x)=(k, x)=ike^{ikx}[1+o(1)], x→+∞. (11)

The transmission coefficient, T, and the reflection coefficient from the left, R, are related to the asymptotics of f₁(k,x) as

$$\begin{matrix}{f}_{l} ( k , x ) = \frac{1}{T ( k )} {ⅇ}^{ⅈ kx} + \frac{R ( k )}{T ( k )} {ⅇ}^{- ⅈ kx} + o ( 1 ) , x \to - ∞ , & ( 12 ) \\ {f}_{l}^{′} ( k , x ) = \frac{ik}{T ( k )} {ⅇ}^{ⅈ kx} - \frac{ik R ( k )}{T ( k )} {ⅇ}^{- ⅈ kx} + o ( 1 ) , x \to - ∞ . & ( 13 )\end{matrix}$$

Since it can be assumed that U(x)=0 for x<0, it then follows that

$$\begin{matrix}{f}_{l} ( k , x ) = \frac{1}{T ( k )} {ⅇ}^{ⅈ kx} + \frac{R ( k )}{T ( k )} {ⅇ}^{- ⅈ kx} , x \leq 0 , & ( 14 ) \\ {f}_{l}^{′} ( k , x ) = \frac{ik}{T ( k )} {ⅇ}^{ⅈ kx} - \frac{ik R ( k )}{T ( k )} {ⅇ}^{- ⅈ kx} , x \leq 0. & ( 15 )\end{matrix}$$

A determination of U from [1−R(k)]/T(k) is then obtained as follows. From equation 15 we see that a determination of [1−R(k)]/T(k) is equivalent to a determination of f (k,0). It should be noted that the amplitude of the reciprocal of this quantity is related to the real part of [1+R(k)]/[1−R(k)]. From this

$$\begin{matrix}Re \{ \frac{1 + R ( k )}{1 - R ( k )} \} = \frac{1 - {\vert R ( k ) \vert}^{2}}{{\vert 1 - R ( k ) \vert}^{2}} \\ = \frac{{\vert T ( k ) \vert}^{2}}{{\vert 1 - R ( k ) \vert}^{2}} \\ = \frac{{k}^{2}}{{\vert {f}_{l}^{′} ( k , 0 ) \vert}^{2}} , k ∈ R ,\end{matrix} \qquad ( 16 )$$

wherein the fact that |T(k)|^{2+|R(k)|}²=1 for kεR has been employed. It should be appreciated that [1+R]/[1−R] is analytic in the upper half of the complex plane, C⁺, continuous in its closure C⁺, and 1+₀(1/k) as k→∞ in C⁺. Thus, by the Schwarz integral formula (the poisson integral formula for half line) L. Ahlfors, Complex analysis, 2^{nd} ed., McGraw-Hill, New York, 21966, the quantity [1+R)/[1−R] is uniquely determined by its real part. Thus, R for kεR is uniquely determined by knowledge of |f (k,0)| for kε[0,+∞). Equivalently, U is therefore uniquely determined by [1−R]/T. Letting

$$ɛ ( k ) \text{:} = \frac{1 + R ( k )}{1 - R ( k )} - 1 , \qquad ( 17 )$$

then from equation 16 if can be determined that

$$Re \{ ɛ ( k ) \} = \frac{{k}^{2}}{{\vert {f}_{l}^{′} ( k , 0 ) \vert}^{2}} - 1 , k ∈ R , \qquad ( 18 )$$

and hence, by the Schwarz integral formula,

$$ɛ ( k ) = \frac{i}{π} {\int }_{- ∞}^{∞} \frac{ⅆ t}{k + i {0}^{+} - t} [ \frac{{t}^{2}}{{\vert {f}_{l}^{′} ( t , 0 ) \vert}^{2}} - 1 ] , k ∈ \overline{{C}^{+}} . \qquad ( 19 )$$

Once ε(k) constructed, R(k) is obtained as

$$R ( k ) = \frac{ɛ ( k )}{2 + ɛ ( k )} , k ∈ \overline{{C}^{+}} . \qquad ( 20 )$$

Having determination R(k) for kεR, U can be constructed by any one of the available methods K. Chadan and P. C. Sabatier, Inverse Problems in Quantum Scattering Theory, 2^{nd} ed., Springer, N.Y., 1989, T. Aktosun and M. Klaus, Inverse theory: problem on the line, Chapter 2.2.4 in: Scattering, eds. E. R. Pike and P. C. Sabatier (Academic Press, London, 2002).

For the above it will be appreciated that, as one example, a speaker identification process can comprise means to capture an incoming voice signal, for example from a microphone or telephone line; means to process the signal electronically to generate a time varying series of binary vocal-tract potentials and associated non-vowel binary parameters; means to refine the signal to revoke the speaker-independent speech components; and means to compare the residual signal with a database of such residual features of known individuals. Also, means to compare the aforementioned binary strings with a table known parsable speech tokens can be provided along with means to parse the token stream to confirm and/or refine interpretation using other grammar and/or context rules; and means to output the interpretation, for example, a computer screen or printing device.

This further example involves again the speaker-independent (bitwise) part of the recovered potential function and could be employed for example, in telephony, particularly mobile telecoms. An important context is the military field, where the need to transmit both speech and e-text leads to shared-bandwidth problems. Recent estimates are that 72 bps speech compression is required, in comparison to current 2.4 kbps. The potential function system will operate at lower than 90 bps.

The removal of the speaker-independent part of the speech in this way facilitates the analysis of the rest of the signal for speaker-identification purposes.

Speech processing security applications are commonly employed in situations involving telephony where communication lines can be automatically interrogated. A method according to the present invention has the benefit of remote operation. This comprises most favourably with, for example, fingerprint and iris patterning which require close contact for the compilation of the initial database of samples and relatively close contact at the automatic scanning stage.

The speech-recognition process uses the speaker-independent part of the recovered binary parameters; primarily the binary strings noted above for the vowels but also the additional non-vowel parameters. As implemented in a grammatical parser in place of, for example, a currently used cepstral coefficients, the applications are extremely wide, as has already been indicated.

Finally, with regard to speech synthesis, an example of the invention comprise means to generate a binary speech token stream for the speaker-independent component of the message to be synthesized, for example, from a database of words or phrases; means to convert the binary steam to a band-limited analogue electrical signal; and means to convert this signal to audible speech such as a loudspeaker

Applications can relate to text-to-speech systems, for personal computing applications and information dissemination including, for example, the speaking clock or railway tannoy systems.

1-51. (canceled)

52. Speech processing apparatus arranged for the input or output of a speech data signal and including a function generating means arranged for producing a representation of a vocal-tract six bit potential function for vowel identification representative of a speech source.

53. An apparatus as claimed in claim 52, and including means for deriving single-bit consonantal features.

54. An apparatus as claimed in claim 53, wherein consonantal sounds are defined as five or six additional bits.

55. As apparatus as claimed in claim 52, and arranged for deriving linguistic parameters representing sonorant sounds from the said 6-bits.

56. An apparatus as claimed in claim 55, wherein the sonorant sounds comprise one or more of nasalised vowels, laterals and rhotics.

57. An apparatus as claimed in claim 55, and arranged to include a further binary parameter with the said 6-bits serving to indicate the absence of periodic voicing at the glottis and/or the presence of aperiodic energy.

58. An apparatus as claimed in claim 55, wherein linguistic parameters in the order of two or three additional bits are defined for consonant sounds.

59. An apparatus as claimed in claim 52, and including means for specifying the said potential function as a general function having parameters serving to discriminate between phonemes.

60. An apparatus as claimed in claim 52, wherein the said function generating means is arranged to perform an inversion algorithm derived from a Green's function solution for a vocal-tract wave function.

61. An apparatus as claimed in claim 52, wherein the said function generating means is arranged to produce potential function strings.

62. An apparatus as claimed in claim 52, and including means for discriminating between speaker dependent and speaker independent parts of the potential function.

63. Speech recognition apparatus including means for receiving a speech data signal and speech processing apparatus as claimed in claim 52, and further including means for conducting a template matching procedure on the output of the function generating means.

64. An apparatus as claimed in claim 63, and including means for performing an inversion calculation on the said speech data signal so as to derive the potential function.

65. An apparatus as claimed in claim 63, wherein the said template matching procedure is arranged to be conducted on a speaker independent part of the potential function.

66. An apparatus as claimed in claim 63, wherein the said means for conducting the template matching procedure is arranged to provide comparison to binary potential function strings stored in look-up tables, and which serves to achieve vocal-tract length normalization.

67. An apparatus as claimed in claim 66, and including parsing means arranged to receive phoneme identifiers output from the template matching means.

68. Voice identification apparatus including means for receiving a data signal, and speech processing apparatus as claimed in claim 52.

69. An apparatus as claimed in claim 68, and including means for performing an inversion calculation on the said speech data signal so as to derive the potential function.

70. An apparatus as claimed in claim 69, and including means for performing a matching operation on stored data identifying individual and on the basis of speaker-dependent parts of the potential function.

71. Speech synthesis apparatus including speech processing apparatus of claim 52, and including means for receiving speech parameters and for reconstructing a speech sound wave on the basis of the said potential function which serves to produce a speech token stream.

72. An apparatus as claimed in claim 71, and arranged such that the speech sound wave is reconstructed having regard to speaker-independent parts of the potential function.

73. An apparatus as claimed in claim 71, and including means for converting a stream of speech tokens into an analogue speech signal.

74. Speech signal compression apparatus including means for receiving a speech data signal, and speech processing apparatus as claimed in claim 52.

75. An apparatus as claimed in claim 74, and including means for performing an inversion calculation on the speech data signals so as to derive the potential function.

76. An apparatus as claimed in claim 74, and including template matching means for receiving the output from the function generating means and for reconstructing speaker independent parts of the potential function as compressed speech data.

77. An apparatus as claimed in 52, wherein the said function generating means is arranged to generate a time varying series of binary vocal-tract potentials and associated non-vowel binary parameters.

78. A speech processing method for processing input or output speech data and including the step of generating a representation of a vocal-tract six bit potential function for vowel identification representative of a speech source.

79. A method as claimed in claim 78, and including the step of specifying the said potential function as a general function having parameters serving to discriminate between phonemes.

80. A method as claimed in claim 78, and including the step of deriving single-bit consonantal features.

81. A method as claimed in claim 78, and including the definition of consonantal sounds as five or six additional bits.

82. A method as claimed in claim 78, and including the step of deriving linguistic parameters representing sonorant sounds for the said 6-bits.

83. A method as claimed in claim 80, wherein the sonorant sounds comprise one ore more of nasalised vowels, laterals and rhotics.

84. A method as claimed in claim 80, and including the step of including a further binary parameter with the said 6-bits serving to indicate the absence of periodic voicing at the glottis and/or the presence of aperiodic energy.

85. A method as claimed in claim 82, wherein linguistic parameters in the order of two or three additional bits are defined for consonant sounds.

86. A method as claimed in claim 78, and including the step of performing an inversion algorithm derived from a Green's function solution for the vocal-tract wave function.

87. A method as claimed in claim 78, and including the step of producing the vocal-tract potential function as potential function strings.

88. A method as claimed in claim 78, and including the step of discriminating between speaker-dependent, and speaker-independent, parts of the potential function.

89. A speech recognition method including the step of receiving a speech data signal and further including the processing steps of claim 78 and also the step of conducting a template matching procedure on the vocal-tract potential function.

90. A method as claimed in claim 89, and including the step of performing an inversion calculation on the speech data signal so as to derive the potential function.

91. A method as claimed in claim 89, wherein the template matching procedure is conducted on a speaker-independent part of the potential function.

92. A method as claimed in claim 89, wherein the step of conducting the template matching procedure includes the step of providing a comparison with binary potential function strings stored in look-up tables.

93. A method as claimed in claim 92, and including the step of parsing received phoneme identifiers resulting from the template-matching step.

94. A voice identification method including the step of receiving a speech data signal and including speech-processing steps such as defined in claim 78.

95. A method as claimed in claim 94, and including the step of specifying the said potential function as a general function having parameters serving to discriminate between phonemes.

96. A method as claimed in claim 95, and including the step of performing a matching operation on the stored data identifying individuals, and on the basis of speaker-dependent parts of the potential function.

97. A speech synthesis method including the processing steps of claim 78, and further including the step of receiving speech parameters and for reconstructing a speech sound wave on the basis of the said potential function.

98. A method as claimed in claim 97, and including the step of reconstructing the speech sound wave having regard to speaker-independent parts of the potential function.

99. A method as claimed in claim 97, and including the step of converting a stream of speech tokens into an analogue speech signal.

100. A speech signal compression method, including the steps of receiving a speech data signal and further including the speech processing steps of claim 78.

101. A method as claimed in claim 100, and including the step of performing an inversion calculation on the speech data signals so as to derive the potential function.

102. A method as claimed in claim 100, and including the step of receiving the result of the potential function and for delivering the same to template matching means and for reconstructing speaker-independent parts of the potential function as compressed speech data.
